(19) United States
(12) Patent Application Publication
(10) Pub. No.: US 2011/0159361 A1
(43) Pub. Date: Jun. 30, 2011

(54) NONAQUEOUS ELECTROLYTE SECONDARY BATTERY AND METHOD FOR PRODUCING THE SAME

(75) Inventors: Hiroshi Minami, Kobe-city (JP); Naoki Imachi, Kobe-city (JP)

(73) Assignee: SANYO ELECTRIC CO., LTD., Osaka (JP)

(21) Appl. No.: 12/977,872

(22) Filed: Dec. 23, 2010

(30) Foreign Application Priority Data
Dec. 25, 2009 (JP) 2009-293733

(51) Int. Cl. H01M 4/00; B05D 5/12

(52) U.S. Cl. 429/209; 427/58

(57) ABSTRACT

A nonaqueous electrolyte secondary battery includes a positive electrode, a negative electrode and a nonaqueous electrolyte. At least one of the positive electrode and the negative electrode is an electrode including a current collector 1, an active material layer 2 provided on the surface of the current collector 1 and containing an aqueous binder, and an inorganic particle layer 3 provided on the active material layer 2 and containing a solvent-based binder. An organic anticorrosive layer 1a is provided at the surface of the current collector 1.

### BACKGROUND OF THE INVENTION

1. Field of the Invention

This invention relates to nonaqueous electrolyte secondary batteries, such as lithium secondary batteries, and particularly relates to nonaqueous electrolyte secondary batteries using an electrode in which an active material layer is provided on a current collector and an inorganic particle layer is provided on the active material layer.

2. Description of Related Arts

Taking advantage of small size and light weight, lithium secondary batteries are used in a variety of applications from small-sized portable devices including cellular phones, notebook computers, game consoles and DSCs to electric power tools, electric power-assisted bicycles, electric scooters, HEVs and EVs.

With the above widespread use, lithium secondary batteries have been developed towards higher capacity and higher power. In high-capacity applications, reflecting influences of recent lithium secondary battery accidents, safety-conscious element techniques have been actively introduced. Also in high-power applications, because of the necessity of replacement for conventional aqueous alkaline batteries having high safety, such as nickel cadmium batteries and nickel hydrogen batteries, safety-conscious element techniques have been actively introduced.

Published Japanese Patent Application No. 2005-174792 proposes a technique in which an inorganic particle layer containing inorganic particles is provided over an electrode or a separator to increase the insulation property between the positive and negative electrodes and prevent internal short-circuit due to production process or source material-derived foreign substances, thereby increasing the battery safety.

However, in order to form an inorganic particle layer over an electrode, it is necessary to first form an active material layer on a current collector and then form an inorganic particle layer on the active material layer. The active material layer is generally formed by applying a slurry containing an active material, a binder and a solvent to the underlying surface. The inorganic particle layer is also generally formed by applying a slurry containing inorganic particles, a binder and a solvent to the underlying surface. Therefore, in forming the inorganic particle layer on the active material layer, the solvent in the slurry for forming the inorganic particle layer may permeate the active material layer, whereby the binder in the active material layer may dissolve or swell in the solvent. In such a case, the active material layer may peel off from the current collector, and the amount of slurry applied on the active material layer becomes difficult to control. To solve these problems, the active material layer must be formed using a binder which will neither dissolve nor swell in the solvent contained in the slurry for forming the inorganic particle layer.

For example, a preferred solution is to form one of the active material and inorganic particle layers using an aqueous binder capable of being formed by an aqueous solvent and form the other using a solvent-based binder capable of being formed by an organic solvent. In light of environmental burden and economy, it is desirable to use an aqueous binder for the active material layer and use a solvent-based binder for the inorganic particle layer.

However, even if an active material layer containing an aqueous binder is provided on a current collector and an inorganic particle layer containing a solvent-based binder is formed on the active material layer, the adhesion between the current collector and the active material layer often decreases.

The inventors have conducted intensive studies on the problem with decrease in adhesion between the current collector and the active material layer and, consequently, have found that an anticorrosive layer formed at the surface of the current collector is involved in the adhesion between the current collector and the active material layer. For example, in using copper foil as a current collector, an acid chromate treatment is generally applied as an anticorrosion treatment.

Published Japanese Patent Applications Nos. H11-273683 and 2008-226800 disclose anticorrosion treatments for copper foil using an organic anticorrosive, such as benzotriazole.

### SUMMARY OF THE INVENTION

An object of the present invention is to provide a nonaqueous electrolyte secondary battery using an electrode in which an active material layer containing an aqueous binder is provided on a current collector and an inorganic particle layer containing a solvent-based binder is provided on the active material layer, wherein the adhesion between the current collector and the active material layer is improved, and provide a method for producing the nonaqueous electrolyte secondary battery.

A nonaqueous electrolyte secondary battery according to the present invention includes a positive electrode, a negative electrode and a nonaqueous electrolyte. At least one of the positive electrode and the negative electrode is an electrode including a current collector, an active material layer provided on the surface of the current collector and containing an aqueous binder, and an inorganic particle layer provided on the active material layer and containing a solvent-based binder. An organic anticorrosive layer is provided at the surface of the current collector.

In the nonaqueous electrolyte secondary battery according to the present invention, an organic anticorrosive layer is provided at the surface of the current collector. The organic anticorrosive layer has a high affinity for the aqueous binder in the active material layer. Therefore, even if in forming an inorganic particle layer on the active material layer an organic solvent in the slurry for forming the inorganic particle layer permeates the active material layer, the decrease in adhesion between the current collector and the active material layer can be reduced. Hence, an electrode can be provided which has an improved adhesion between the current collector and the active material layer, whereby the reliability of the battery characteristics can be increased.

An organic anticorrosive used for forming the organic anticorrosive layer may be at least one compound selected from the group consisting of triazole compounds and tetrazole compounds. Therefore, the organic anticorrosive layer preferably contains at least one compound selected from the group consisting of triazole compounds and tetrazole compounds. Note that in the present invention the term “contain” used when the organic anticorrosive layer contains a compound encompasses the case where it contains the compound in the form of a salt, a complex or the like with a metal constituting the current collector. The triazole compounds include benzotriazole, methylbenzotriazole, aminobenzotriazole and carboxybenzotriazole. The tetrazole compounds include 1H-tetrazole monoethanolamine salt and tetrazole derivatives. Among these compounds, from standpoints of anticorrosion effect and electrochemical stability, the particularly preferred are benzotriazole and 1H-tetrazole monoethanolamine salt.

If the organic anticorrosive contains only at least one of a triazole compound and a tetrazole compound, it is difficult to uniformly apply the organic anticorrosive in a thin layer on the surface of the current collector. Thus, the surface of the current collector may remain locally untreated with the organic anticorrosive and part of the current collector may be exposed. In order to uniformly apply the organic anticorrosive on the current collector, the organic anticorrosive preferably contains not only at least one compound selected from the group consisting of triazole compounds and tetrazole compounds but also an amine compound. Therefore, the organic anticorrosive layer more preferably contains at least one compound selected from the group consisting of triazole compounds and tetrazole compounds and an amine compound. If the organic anticorrosive contains an amine compound, the organic anticorrosive can be uniformly applied on the current collector and the organic anticorrosive layer can be thereby uniformly formed.

The mixture ratio between at least one compound selected from triazole compounds and tetrazole compounds (hereinafter referred to as a “triazole compound or the like”) and an amine compound, i.e., the triazole compound or the like to amine compound ratio, by weight, is preferably 1:0.5 to 1:5. However, more preferably, the organic anticorrosive contains these compounds so that the amine compound has a higher concentration than the triazole compound or the like.

The amine compound preferably used is triethanolamine. The use of triethanolamine enables a uniform application of the anticorrosive to increase the anticorrosion effect and further improve the adhesion between the current collector and the active material layer.

Therefore, the organic anticorrosive particularly preferably contains benzotriazole and triethanolamine.

In the current collector at which the organic anticorrosive layer is formed, the reciprocal of electric double layer capacity (1/C) on at least one side of the current collector is preferably 0.3 to 1.0 cm²/μF. More preferably, the reciprocal of electric double layer capacity (1/C) is 0.4 to 1.0 cm²/μF. When the reciprocal of electric double layer capacity (1/C) on the surface of the current collector is determined, the thicknesses of the organic anticorrosive layer and the natural oxide layer can be evaluated.

If the reciprocal of electric double layer capacity (1/C) is below 0.3 cm²/μF, the organic anticorrosive is difficult to uniformly apply. If the reciprocal of electric double layer capacity (1/C) is below 0.4 cm²/μF, the thicknesses of the organic anticorrosive layer and the natural oxide layer are small, whereby the adhesion between the current collector and the active material layer may not be able to be sufficiently improved. On the other hand, if the reciprocal of electric double layer capacity (1/C) is above 1.0 cm2/μF, the thicknesses of the organic anticorrosive layer and the natural oxide layer are too large, whereby the electrical conductivity of the current collector may be lowered to decrease the battery characteristics.

The electric double layer capacity can be measured with any commercially available direct-reading electric double layer capacity meter. The reciprocal of electric double layer capacity (1/C) can be determined from the following equation.

1/C=A·d+B

where d represents the thickness of the electric double layer formed on the surface of the current collector, and A and B represent constants.

A method for producing a nonaqueous electrolyte secondary battery according to the present invention is a method that can produce the nonaqueous electrolyte secondary battery according to the present invention, and includes the steps of: forming the organic anticorrosive layer on the surface of the current collector by treating the surface of the current collector with at least one kind of organic anticorrosive; forming the active material layer on the organic anticorrosive layer by applying a slurry containing an aqueous binder, an active material and an aqueous solvent on the organic anticorrosive layer; forming the inorganic particle layer on the active material layer by applying a slurry containing a solvent-based binder, inorganic particles and an organic solvent on the active material layer, thereby producing an electrode; and producing a nonaqueous electrolyte secondary battery using the electrode as a positive electrode or a negative electrode.

According to the production method of the present invention, a nonaqueous electrolyte secondary battery can be produced in which the electrode provided with an inorganic particle layer has an improved adhesion between the current collector and the active material layer, and the reliability of the battery characteristics can be increased.

The electrode provided with an inorganic particle layer may be a positive electrode or a negative electrode. In order to significantly improve the cycle life and shelf life characteristics, the negative electrode is preferably provided with an inorganic particle layer. If the negative electrode is provided with an inorganic particle layer, eluted and/or decomposed materials from the positive electrode can be trapped on the surface of the inorganic particle layer and the surface of the negative electrode is not directly covered with deposits. Therefore, the flow of the electrolytic solution is not reduced, and the deterioration in cycle life and shelf life characteristics can be reduced.

Examples of the kind of inorganic particles that can be used for the inorganic particle layer include titania, alumina, zirconia and magnesia. In consideration of stability in the battery (reactivity with Li) and cost, the preferred kind of inorganic particles is alumina or rutile titania. Particularly, rutile titania has a better dispersibility in the slurry and thus enables the formation of a homogeneous inorganic particle layer. Therefore, the inorganic particle layer preferably contains rutile titania. On the other hand, the use of anatase titania is undesirable because anatase titania can insert and eliminate Li ions and may store Li ions depending on environmental atmosphere and potential to develop electron conductivity, which may cause capacity reduction or short-circuit.

In consideration of dispersibility in the slurry, these inorganic particles are particularly preferably surface treated with Al, Si or Ti.

The average particle size of the inorganic particles is preferably not greater than 1 μm. However, in consideration of reduction of damage to the separator from peeled particles due to decrease in adhesion strength and inhibition of entry of the peeled particles into separator micropores, the average particle size is particularly preferably greater than the average pore size of the separator. Generally, the average particle size is preferably 100 nm or more.

The binder used for the inorganic particle layer preferably should satisfy all the following properties: (1) reliable dispersibility of inorganic particles (prevention of reaggregation), (2) reliable adhesion that can withstand the battery production process, (3) filling of spaces between inorganic particles through swelling after the absorption of the electrolytic solution and (4) less elution of the electrolytic solution. In order to ensure the battery performance, it can be assumed that the above effects can be exhibited with a small amount of binder. Therefore, in view of the influences on the battery performance, the amount of binder added is preferably not more than 30% by mass with respect to the total amount of the slurry containing inorganic particles, more preferably not more than 10% by mass, and still more preferably 0.5% to 5% by mass. Furthermore, the binder used for the inorganic particle layer is preferably a solvent-based binder with which a solution or a dispersion can be prepared using an organic solvent. Specific examples of the binder include PTFE (polytetrafluoroethylene), PVDF (poly(vinylidene fluoride)), PAN (polyacrylonitrile), SBR (styrene-butadiene rubber), their modified products and derivatives, copolymers containing acrylonitrile units, and polyacrylic acid derivatives. Focusing particularly on the advantage that the properties (1) and (3) can be ensured with a small amount added, the dispersibility in the slurry and the electrode flexibility, the preferred binders are copolymers containing acrylonitrile units.

Examples of the organic solvent used in the slurry for forming the inorganic particle layer include N-methyl-2-pyrrolidone (NMP), cyclopentane and diglyme.

The thickness of the inorganic particle layer is not particularly limited. However, if the inorganic particle layer is formed on each side of the current collector, the thickness is preferably not less than 1 μm in total of both sides. If the inorganic particle layer is formed on one side of the current collector, the thickness is preferably not less than 0.5 μm. However, if the thickness of the inorganic particle layer is too large, the load characteristics and energy density of the battery are reduced. Therefore, the thickness on each side of the current collector is preferably not more than 4 μm, and more preferably not more than 2 μm.

In producing a slurry for forming an inorganic particle layer, the preferred methods for dispersing inorganic particles are wet dispersion methods using a disperser, such as “FILMIX®”, a bead mill, a roll mill or the like. The particle size of inorganic particles is generally small. Therefore, if inorganic particles are not subjected to mechanical dispersion, inorganic particles in the slurry are likely to settle out, whereby a homogeneous film cannot be formed. Hence, the above methods commonly used to disperse paint in the paint industry are preferably used to produce the slurry.

Applicable methods for applying on the active material layer a slurry for forming an inorganic particle layer include die coating, gravure coating, dip coating, curtain coating and spray coating. To limit the application on unnecessary parts and enhance the precision of the film thickness, gravure coating or die coating is preferably used. In using spray coating, dip coating or curtain coating, it is desirable that the solid content concentration in the coating liquid be low. Therefore, the solid content concentration in the slurry is preferably 3% to 30% by mass. On the other hand, in using die coating or gravure coating, the coating liquid can have a high solid content concentration. Therefore, the solid content concentration in the slurry is preferably about 5% to about 70% by mass.

As described previously, the slurry for forming the active material layer contains an aqueous binder, an active material and an aqueous solvent. Examples of the aqueous binder include SBR (styrene-butadiene rubber), acrylic binders, PTFE, CMC (carboxymethyl cellulose), PVP (polyvinylpyrrolidone) and HEC (hydroxyethyl cellulose).

The aqueous binder is particularly preferably used in a combination of a water-soluble polymer, such as CMC, and SBR. SBR has a high Li ion conductivity and therefore provides good battery characteristics. If SBR is used for the aqueous binder, the amount of SBR added is preferably 0.5% to 1.6% by mass with respect to the mass of the active material. If the amount of SBR added is below 0.5% by mass, this may not provide a sufficient adhesion to the current collector. On the other hand, if the amount of SBR added is above 1.6% by mass, the battery characteristics may be decreased.

The amount of water-soluble polymer, such as CMC, to be added is preferably 0.5% to 2.0% by mass with respect to the mass of the active material. If the amount of water-soluble polymer is below 0.5% by mass, a slurry having stable dispersibility may not be obtained. On the other hand, if the amount of water-soluble polymer added is above 2.0% by mass, the battery characteristics may be decreased.

The negative-electrode active material that can be used is not particularly limited so long as it can be used as a negative-electrode active material for a nonaqueous electrolyte secondary battery. Examples of the negative-electrode active material include carbon materials, such as graphite and coke, metal oxides, such as tin oxide, metals that can form an alloy with lithium to store lithium, such as silicon and tin, and metal lithium. The negative-electrode active materials particularly preferably used in the present invention are carbon materials, such as graphite.

Examples of the positive-electrode active material that can be used include layered compounds including lithium cobaltate and other lithium-transition metal composite oxides, such as lithium-cobalt-nickel-manganese composite oxide.

The solvent for the nonaqueous electrolyte used is not particularly limited, but an example of the solvent is a mixture solvent of a cyclic carbonate, such as ethylene carbonate, propylene carbonate or butylene carbonate, and a chain carbonate, such as dimethyl carbonate, methyl ethyl carbonate or diethyl carbonate. Another example of the solvent is a mixture solvent of the above cyclic carbonate and an ether solvent, such as 1,2-dimethoxyethane or 1,2-diethoxyethane.

Examples of the solute for the nonaqueous electrolyte include LiPF₆, LiBF₄, LiCF₃SO₃, LiN(CF₃SO₂)₂, LiN(C₂F₅SO₂)₂, LiN(CF₃SO₂) (C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂ and their mixtures. The solutes particularly preferably used are mixture solutes of LiXF_{y} (where X represents P, As, Sb, B, Bi, Al, Ga or In, y is 6 if X is P, As or Sb and y is 4 if X is Bi, Al, Ga or In) and lithium perfluoroalkylsulfonic acid imide LiN(CₘF₂ₘ₊₁SO₂) (CₙF₂ₙ₊₁SO₂) (where m and n are independently integers from 1 to 4) or lithium perfluoroalkylsulfonic acid methide LiN(CₚF₂ₚ₊₁SO₂) (C_{q}F_{2q+1}SO₂) (CᵣF₂ᵣ₊₁SO₂) (where p, q and r are independently integers from 1 to 4). Among these, the particularly preferred is a mixture solute of LiPF₆ and LiN(C₂F₅SO₂)₂.

Examples of the electrolyte that can be used include gel polymer electrolytes in which a polymer electrolyte, such as polyethylene oxide or polyacrylonitrile, is impregnated with an electrolytic solution, and inorganic solid electrolytes, such as LiI and Li₃N.

The nonaqueous electrolyte secondary battery can be produced using the above-described positive electrode, negative electrode and nonaqueous electrolyte. A separator is generally disposed between the positive and negative electrodes. In this state, the separator and the positive and negative electrodes are placed into an outer package and the nonaqueous electrolyte is then poured into the outer package, thereby producing a nonaqueous electrolyte secondary battery.

### BRIEF DESCRIPTION OF THE DRAWINGS

FIG. 1 is a cross-sectional view showing an electrode provided with an inorganic particle layer.

### DETAILED DESCRIPTION

The present invention is not limited at all by the following embodiments and can be embodied in various other forms appropriately modified without changing the spirit of the invention.

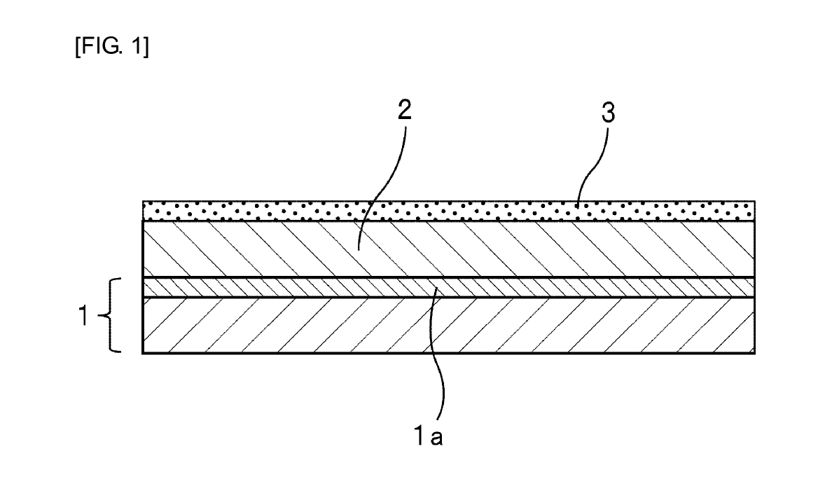

FIG. 1 is a cross-sectional view showing an electrode provided with an inorganic particle layer.

As shown in FIG. 1, an inorganic anticorrosive layer 1a is formed on a surface of a current collector 1 by treating the surface with at least one kind of organic anticorrosive. The organic anticorrosive layer 1a can be typically formed by applying a solution containing an organic anticorrosive to the surface of the current collector 1 and then drying the solution.

Applicable solvents for the solution of organic anticorrosive include alcohols and other organic solvents, but the preferred solvent to be used is water consisting essentially of deionized water. The use of water as the solvent enables the formation of a uniform organic anticorrosive layer, which is preferable also from an environmental standpoint.

The content of organic anticorrosive in the solution is preferably 1 to 5000 ppm, and more preferably 50 to 3000 ppm.

The pH value of the solution of organic anticorrosive is preferably within the range of 5.0 to 8.5. If the pH value is below 5.0, it may be impossible to stably form the organic anticorrosive layer. On the other hand, if the pH value is above 8.5, an oxide layer becomes likely to be formed on the surface of the current collector, whereby it may be impossible to form a stable organic anticorrosive layer.

If the electrode to be provided with an inorganic particle layer 3 is a negative electrode, copper foil is generally used as a current collector 1. Examples of the copper foil that can be used include electrolytic copper foil and rolled copper foil. Alternatively, copper alloy foil may be used as a current collector 1.

If the electrode to be provided with an inorganic particle layer 3 is a positive electrode, aluminum foil, for example, is used as a current collector 1.

The thickness of the current collector is not particularly limited but is preferably 6 to 20 μm from the standpoints of handling and battery capacity.

An active material layer 2 is formed on the surface of the current collector 1 at which the inorganic anticorrosive layer 1a is formed. The active material layer 2 is formed by applying a slurry containing an aqueous binder, an active material and an aqueous solvent on the surface of the current collector 1 and then drying the slurry.

An inorganic particle layer 3 is formed on top of the active material layer 2 by applying a slurry containing a solvent-based binder, inorganic particles and an organic solvent on the active material layer 2 and then drying the slurry.

In this case, when the slurry for forming the inorganic particle layer 3 is applied on the active material layer 2, the organic solvent contained in the slurry, such as NMP, permeates the active material layer 2. If the anticorrosive layer 1a is a layer obtained by a conventional acid chromate treatment, the organic solvent having permeated the active material layer 2, such as NMP, may decrease the adhesion between the current collector 1 and the active material layer 2, resulting in decreased battery characteristics. The anticorrosion effect may also be decreased.

In addition, if SBR, for example, is used as a binder for the active material layer 2, SBR may swell in the organic solvent having permeated the active material layer 2, such as NMP, resulting in further decreased adhesion of the active material layer 2 to the current collector 1.

In contrast, since in this embodiment the organic anticorrosive layer 1a is formed using an organic anticorrosive, even if an organic solvent, such as NMP, permeates the active material layer 2, the decrease in adhesion between the current collector 1 and the active material layer 2 can be reduced because good affinity between the organic anticorrosive layer 1a and the active material layer 2.

Although in FIG. 1 only one side of the current collector 1 is provided with an organic anticorrosive layer 1a, an active material layer 2 and an inorganic particle layer 3, each side of the current collector 1 may be provided with an organic anticorrosive layer 1a, an active material layer 2 and an inorganic particle layer 3.

### EXAMPLES

Hereinafter, the present invention will be described with reference to specific examples. However, the present invention is not limited at all by the following examples and can be embodied in various other forms appropriately modified without changing the spirit of the invention.

[Production of Negative Electrode Current Collector]

To produce electrolytic copper foil to be used as a negative electrode current collector, a solution containing ingredients listed below was prepared under conditions described below.
Copper: 70 to 130 g/L
Sulfuric acid: 80 to 140 g/L
Additives: 1 to 10 ppm of 3-mercapto-1-sodium propanesulfonate,
   1 to 100 ppm of hydroxyethyl cellulose, and
   1 to 50 ppm of low-molecular-weight glue (with a MW of 3000)
Chloride ion concentration: 10 to 50 ppm
Temperature: 50° C. to 60° C.

A 10 μm-thick sheet of electrolytic copper foil was produced by using a precious metal oxide-coated titanium electrode as an anode and a rotating drum made of titanium as a cathode and performing electrolysis with a current density of 50 to 100 A/dm² using the above electrolytic solution.

Pieces of the obtained electrolytic copper foil were treated with respective organic anticorrosives as described in Examples and Comparative Example below. Thus, current collectors were provided which having their respective organic anticorrosive layers formed on their surfaces, and used as negative electrode current collectors.

[Production of Negative Electrode]

A 1.0% by mass CMC aqueous solution was prepared by dissolving CMC (Grade 1380 manufactured by Daicel Chemical Industries, Ltd.) in deionized water using a homomixer manufactured by PRIMIX Corporation. Next, 1000 g of the CMC aqueous solution and 980 g of artificial graphite (average particle size: 21 μm, surface area: 4.0 m²/g) were weighed and mixed using a homomixer manufactured by PRIMIX Corporation. Thereafter, 20 g of SBR (solid content concentration: 50% by mass) was added to the mixture, thereby preparing a slurry for a negative electrode. The mass ratio of artificial graphite to CMC to SBR was 98.0:1.0:1.0.

The slurry was applied on both surfaces of each current collector using a reverse coating technique, then dried and rolled, thereby forming negative-electrode active material layers on both surfaces of the negative electrode current collector. The amount of slurry applied for the negative-electrode active material layers was 226 mg per 10 cm² in total of both surfaces of the current collector, and the negative electrode packing density was 1.60 g/cm³.

(Formation of Inorganic Particle Layer)

Using NMP as a solvent, rutile titanium oxide (average diameter: 0.25 μm, trade name CR-EL manufactured by Ishihara Sangyo Kaisha, Ltd.) was mixed into the solvent to reach a solid content concentration of 30% by mass. Next added to the mixture was a copolymer containing acrylonitrile structures (units) to give 3.0% by mass with respect to titanium oxide. After the addition, using a disperser “FILMIX®” manufactured by PRIMIX Corporation, the resultant product was mixed to disperse titanium oxide, thereby preparing a slurry for forming an inorganic particle layer.

The slurry was applied on the active material layers on both surfaces of the above negative electrode by microgravure coating and then dried, thereby forming inorganic particle layers on the active material layers. The inorganic particle layers were formed by applying the slurry on one side after the other of the negative electrode.

[Production of Positive Electrode]

Lithium cobaltate was used as an active material for each positive electrode. The positive-electrode active material, acetylene black serving as a conductive carbon material and PVDF serving as a binder were mixed in a mass ratio of 95:2.5:2.5 into NMP serving as a solvent with a kneader “COMBI MIX®” manufactured by PRIMIX Corporation, thereby preparing a slurry for a positive electrode mixture.

The slurry was applied on both surfaces of each piece of aluminum foil, then dried and rolled, thereby obtaining a positive electrode.

[Preparation of Nonaqueous Electrolytic Solution]

Ethylene carbonate (EC) and diethyl carbonate (DEC) were mixed to give an EC:DEC volume ratio of 3:7. Added to the resultant mixture solvent was LiPF₆ to reach a concentration of 1 mol/L, thereby preparing an electrolytic solution.

[Assembly of Battery]

Lead terminals were attached to the above positive and negative electrodes, a separator was interposed between the positive and negative electrodes, and these components were helically wound up together and pressed down in a flattened form, thereby producing an electrode assembly. The electrode assembly was inserted into an aluminum laminate serving as a battery outer package, the above nonaqueous electrolytic solution was then poured into the aluminum laminate, and the aluminum laminate was then sealed, thereby producing a test battery. The design capacity of each battery was 850 mAh.

The battery was designed to have an end-of-charge voltage of 4.4 V and designed so that the capacity ratio between positive and negative electrodes (first charge capacity of negative electrode to first charge capacity of positive electrode) at 4.4 V was 1.08.

[Anticorrosion Treatment of Negative Electrode Current Collector]

### Example 1

An aqueous solution of 250 ppm of benzotriazole and 300 ppm of triethanolamine was used as a solution of organic anticorrosive. A negative electrode current collector was immersed into the aqueous solution for ten seconds, then picked up and dried. The product thus obtained was a negative electrode current collector at the surface of which an organic anticorrosive layer was formed.

The obtained negative electrode current collector was measured in terms of reciprocal of electric double layer capacity with a direct-reading electric double layer capacity meter. The reciprocal of electric double layer capacity (1/C) was 0.61 cm²/μF.

An active material layer and an inorganic particle layer were formed in the above manner using the obtained current collector, thereby producing a negative electrode t1.

### Example 2

An aqueous solution of 500 ppm of benzotriazole and 600 ppm of triethanolamine was used as a solution of organic anticorrosive. A negative electrode current collector was immersed into the aqueous solution for ten seconds, then picked up and dried. The product thus obtained was a negative electrode current collector at the surface of which an organic anticorrosive layer was formed.

The obtained negative electrode current collector was measured in terms of reciprocal of electric double layer capacity with a direct-reading electric double layer capacity meter. The reciprocal of electric double layer capacity (1/C) was 0.49 cm²/μF.

An active material layer and an inorganic particle layer were formed in the above manner using the obtained current collector, thereby producing a negative electrode t2. Furthermore, a battery T2 was produced using the negative electrode t2.

### Example 3

An aqueous solution of 1000 ppm of benzotriazole and 1200 ppm of triethanolamine was used as a solution of organic anticorrosive. A negative electrode current collector was immersed into the aqueous solution for ten seconds, then picked up and dried. The product thus obtained was a negative electrode current collector at the surface of which an organic anticorrosive layer was formed.

The obtained negative electrode current collector was measured in terms of reciprocal of electric double layer capacity with a direct-reading electric double layer capacity meter. The reciprocal of electric double layer capacity (1/C) was 0.50 cm²/μF.

An active material layer and an inorganic particle layer were formed in the above manner using the obtained current collector, thereby producing a negative electrode t3.

### Example 4

An aqueous solution of 2000 ppm of benzotriazole and 2400 ppm of triethanolamine was used as a solution of organic anticorrosive. A negative electrode current collector was immersed into the aqueous solution for ten seconds, then picked up and dried. The product thus obtained was a negative electrode current collector at the surface of which an organic anticorrosive layer was formed.

The obtained negative electrode current collector was measured in terms of reciprocal of electric double layer capacity with a direct-reading electric double layer capacity meter. The reciprocal of electric double layer capacity (1/C) was 0.93 cm²/μF.

An active material layer and an inorganic particle layer were formed in the above manner using the obtained current collector, thereby producing a negative electrode t4.

### Example 5

An aqueous solution to which only 500 ppm of benzotriazole was added was used as a solution of organic anticorrosive. A negative electrode current collector was immersed into the aqueous solution for ten seconds, then picked up and dried. The product thus obtained was a negative electrode current collector at the surface of which an organic anticorrosive layer was formed.

The obtained negative electrode current collector was measured in terms of reciprocal of electric double layer capacity with a direct-reading electric double layer capacity meter. The reciprocal of electric double layer capacity (1/C) was 0.33 cm²/μF.

An active material layer and an inorganic particle layer were formed in the above manner using the obtained current collector, thereby producing a negative electrode t5.

### Example 6

An organic anticorrosive layer was formed using an aqueous solution containing as an organic anticorrosive a combination of 500 ppm of 1H-tetrazole monoethanolamine salt, which is a tetrazole compound, and 600 ppm of triethanolamine.

The obtained negative electrode current collector was measured in terms of reciprocal of electric double layer capacity with a direct-reading electric double layer capacity meter. The reciprocal of electric double layer capacity (1/C) was 0.86 cm²/μF.

An active material layer and an inorganic particle layer were formed in the above manner using the obtained current collector, thereby producing a negative electrode t6. Furthermore, a battery T6 was produced using the negative electrode t6.

### Comparative Example 1

A current collector was subjected to anticorrosion by an acid chromate treatment using an aqueous solution in which 25 g/L of CrO₃ was dissolved. An active material layer and an inorganic particle layer were formed on the obtained current collector, thereby producing a negative electrode r1. Furthermore, a battery R1 was produced using the negative electrode r1.

[Evaluation of Anticorrosion Effect]

Each of the current collectors used for the negative electrodes t2, t5, t6 and r1 was subjected to heat treatment at 150° C. for 30 minutes and then evaluated in terms of anticorrosion effect by observing the surface conditions of each current collector after the heat treatment. The evaluation results are shown in TABLE 1.

TABLE 1

| | | Anticorrosive | TEA | | |
|---|---|---|---|---|---|
| Current | | Concentration | Concentration | | |
| Collector | Anticorrosive | (ppm) | (ppm) | Surface Conditions | |
| t2 | BTA | 500 | 600 | ◯ | Unchanged |
| t5 | BTA | 500 | 0 | Δ | Partly Discolored |
| t6 | Tetrazole | 500 | 600 | ◯ | Unchanged |
| r1 | Acid Chromate | — | — | X | Completely Discolored |

BTA: Benzotriazole
TEA: Triethanolamine

TABLE 1 shows that the organic anticorrosion treatment according to the present invention improved the anticorrosion effect as compared with the conventional acid chromate treatment. The current collector t5, for which no triethanolamine (TEA) was used, was found to be partly discolored unlike the current collector t2 for which TEA was used. This reveals that the addition of triethanolamine (TEA) to the anticorrosive enables the formation of a uniform anticorrosive layer.

[Evaluation of Adhesion Between Active Material Layer and Current Collector]

Each of the above negative electrodes was evaluated in terms of adhesion between the current collector and the active material layer by a 90 degree peel test.

Specifically, each negative electrode was attached onto a 120 mm×30 mm acrylic plate through a 70 mm×20 mm adhesive double-faced tape (“NAISTAK® NW-20” manufactured by Nichiban Co., Ltd.). An end of the negative electrode attached to the acrylic plate was pulled 55 mm upward from and at a right angle with the surface of the negative electrode at a constant rate (50 mm/min), thereby measuring the peeling strength upon peel-off. The measurement of the peeling strength was conducted three times, and the average value of the three measurement results was determined as a 90 degree peeling strength. The results are shown in TABLE 2. The instruments used for the evaluation were a small desktop testing machine “FGS-TV” and a force gauge “FGP-5” both manufactured by Nidec-Shimpo Corporation.

The adhesion is indicated by a relative value, taking as 100 the adhesion of a negative electrode using a current collector not yet provided with an inorganic particle layer and subjected to an acid chromate treatment. The adhesion retention is a value representing the proportion of adhesion after the formation of the inorganic particle layer to adhesion before the formation of the inorganic particle layer.

TABLE 2

| | | | | Reciprocal of | Adhetion (%) | | |
|---|---|---|---|---|---|---|---|
| | | Anticorrosive | TEA | Electric Double | Before Formation | After Formation | Adhesion |
| Negative | | Concentration | Concentration | Layer Capacity | of Inorganic | of Inorganic | Retention |
| Electrode | Anticorrosive | (ppm) | (ppm) | (1/C, cm²/μF) | Particle Layer | Particle Layer | (%) |
| t1 | BTA | 250 | 300 | 0.61 | 109 | 83 | 76 |
| t2 | BTA | 500 | 600 | 0.49 | 105 | 87 | 83 |
| t3 | BTA | 1000 | 1200 | 0.50 | 103 | 88 | 85 |
| t4 | BTA | 2000 | 2400 | 0.93 | 102 | 92 | 90 |
| t5 | BTA | 500 | 0 | 0.33 | 86 | 69 | 80 |
| t6 | Tetrazole | 500 | 600 | 0.86 | 85 | 72 | 84 |
| r1 | Acid Chromate | — | — | 0.25 | 100 | 62 | 62 |

The results shown in TABLE 2 reveal that the negative electrodes t1 to t6 using current collectors in which an organic anticorrosive layer was formed using an organic anticorrosive according to the present invention improved the adhesion retention and the adhesion between the active material layer and the current collector, as compared with the negative electrode r1 subjected to the conventional acid chromate treatment.

Comparison of the negative electrodes t1 to t4 with the negative electrode t5 shows that the negative electrodes containing TEA added thereto exhibited higher adhesion retentions and improved the adhesion between the active material layer and the current collector.

Furthermore, comparison among the negative electrodes t1 to t4 shows that the negative electrode having higher concentrations of anticorrosive and TEA exhibited higher adhesion retention and more significantly improved the adhesion between the active material layer and the current collector.

Comparison of the negative electrodes t1 to t6 with the negative electrode r1 shows that the reciprocal of electric double layer capacity (1/C) is preferably 0.3 to 1.0 cm²/μF. Furthermore, comparison of the negative electrodes t1 to t4 with the negative electrode t5 reveals that the reciprocal of electric double layer capacity (1/C) is preferably 0.4 to 1.0 cm²/μF.

[60° C. Storage Test]

The battery T2 using the negative electrode t2, the battery T6 using the negative electrode t6 and the battery R1 using the negative electrode r1 were subjected to a 60° C. storage test in the following manner.

Each battery was subjected to a single charge-discharge cycle test at a rate of 1 It, then charged again to a set voltage of 4.4 V and then allowed to stand at 60° C. for 20 days. Thereafter, the battery was cooled down to room temperature and discharged at a rate of 1 It, and the remaining capacity rate was then calculated from the following equation.

Remaining capacity rate (%)={(first discharge capacity after storage test)/(discharge capacity before storage test)}×100

TABLE 3

| | | | | Percentage |
|---|---|---|---|---|
| | | Anticorrosive | TEA | of |
| | | Concentration | Concentration | Remaining |
| Battery | Anticorrosive | (ppm) | (ppm) | Shelf Life |
| T2 | BTA | 500 | 600 | 84% |
| T6 | Tetrazole | 500 | 600 | 82% |
| R1 | Acid Chromate | — | — | 81% |

As shown in TABLE 3, even if the battery uses a negative electrode subjected to an anticorrosion treatment using an organic anticorrosive, the effect of improving the shelf life characteristics is obtained as in the battery using a negative electrode subjected to the conventional acid chromate treatment.

What is claimed is:

1. A nonaqueous electrolyte secondary battery including a positive electrode, a negative electrode and a nonaqueous electrolyte, wherein
at least one of the positive electrode and the negative electrode is an electrode including a current collector, an active material layer provided on the current collector and containing an aqueous binder, and an inorganic particle layer provided on the active material layer and containing a solvent-based binder,
an organic anticorrosive layer is provided at the surface of the current collector, and
the active material layer is provided on the organic anticorrosive layer.

2. The nonaqueous electrolyte secondary battery according to claim 1, wherein the organic anticorrosive layer contains at least one compound selected from the group consisting of triazole compounds and tetrazole compounds.

3. The nonaqueous electrolyte secondary battery according to claim 1, wherein the organic anticorrosive layer contains at least one compound selected from the group consisting of triazole compounds and tetrazole compounds.

4. The nonaqueous electrolyte secondary battery according to claim 3, wherein
the organic anticorrosive layer contains a triazole compound, and
the triazole compound is benzotriazole and the amine compound is triethanolamine.

5. The nonaqueous electrolyte secondary battery according to claim 1, wherein the aqueous binder contains styrene-butadiene rubber.

6. The nonaqueous electrolyte secondary battery according to claim 1, wherein the surface of the current collector is provided with a natural oxide film and the organic anticorrosive layer.

7. A method for producing the nonaqueous electrolyte secondary battery according to claim 1, the method comprising the steps of:
forming the organic anticorrosive layer on the surface of the current collector by treating the surface of the current collector with an organic anticorrosive;
forming the active material layer on the organic anticorrosive layer by applying a slurry containing an aqueous binder, an active material and an aqueous solvent on the organic anticorrosive layer;
forming the inorganic particle layer on the active material layer by applying a slurry containing a solvent-based binder, inorganic particles and an organic solvent on the active material layer, thereby producing an electrode; and
producing a nonaqueous electrolyte secondary battery using the electrode as a positive electrode or a negative electrode.

8. The method for manufacturing the nonaqueous electrolyte secondary battery according to claim 7, wherein the organic solvent is N-methyl-2-pyrrolidone.
